(19) United States
(12) Patent Application Publication
(10) Pub. No.: US 2026/0205552 A1
(43) Pub. Date: Jul. 16, 2026

(54) DOCUMENT READING DEVICE, IMAGE FORMING APPARATUS, AND IMAGE FORMING SYSTEM

(71) Applicant: Shinya TAKAI, Kanagawa (JP)

(72) Inventor: Shinya TAKAI, Kanagawa (JP)

(73) Assignee: ETRIA CO., LTD., Yokohama (JP)

(21) Appl. No.: 19/368,844

(22) Filed: Oct. 24, 2025

(30) Foreign Application Priority Data
Jan. 10, 2025 (JP) 2025-004411

(51) Int. Cl. H04N 1/00; G03G 15/00

(52) U.S. Cl. CPC H04N 1/00771; G03G 15/602; G03G 15/605; G03G 15/607; H04N 1/00663; H04N 1/00708; H04N 1/00718; H04N 1/00748; H04N 1/00779; G03G 2215/00215; G03G 2215/00329; H04N 1/0066; H04N 1/00793

(57) ABSTRACT

A document reading device includes a document stacker on which a document is placed, a conveyor, a reader, a document presser, a detector, and circuitry. The conveyor conveys the document placed on the document stacker. The reader reads the document conveyed by the conveyor. The document presser is movable between a contact position at which the document presser contacts the document placed on the document stacker and a retracted position at which the document presser is retracted from the document. The detector detects whether the document presser is present at one or both of the contact position and the retracted position. The circuitry performs control based on a detection result of the document presser detected by the detector.

### CROSS-REFERENCE TO RELATED APPLICATION

This patent application is based on and claims priority pursuant to 35 U.S.C. § 119(a) to Japanese Patent Application No. 2025-004411, filed on Jan. 10, 2025, in the Japan Patent Office, the entire disclosure of which is hereby incorporated by reference herein.

### BACKGROUND

### Technical Field

The present disclosure relates to a document reading device, an image forming apparatus, and an image forming system.

### Related Art

A technique is disclosed for conveying small-size documents without skewing, even when large-size and small-size documents are mixed. Although the widthwise edges of the small-size document are not guided, the document is pressed by a roller upstream from the feeding roller in the feeding direction, thus being stably conveyed.

### SUMMARY

The present disclosure described herein provides a document reading device including a document stacker on which a document is placed, a conveyor, a reader, a document presser, a detector, and circuitry. The conveyor conveys the document placed on the document stacker. The reader reads the document conveyed by the conveyor. The document presser is movable between a contact position at which the document presser contacts the document placed on the document stacker and a retracted position at which the document presser is retracted from the document. The detector detects whether the document presser is present at one or both of the contact position and the retracted position. The circuitry performs control based on a detection result of the document presser detected by the detector.

The present disclosure described herein provides an image forming apparatus including a document stacker on which a document is placed, a conveyor, a reader, an image forming device, a document presser, a detector, and circuitry. The conveyor conveys the document placed on the document stacker. The reader reads the document conveyed by the conveyor. The image forming device forms an image on a recording medium based on an image read by the reader. The document presser is movable between a contact position at which the document presser contacts the document placed on the document stacker and a retracted position at which the document presser is retracted from the document. The detector detects whether the document presser is present at one or both of the contact position and the retracted position. The circuitry performs control based on a detection result of the document presser detected by the detector.

The present disclosure described herein provides an image forming system including a document reading device and a server. The document reading device includes a document stacker on which a document is placed, a conveyor, a reader, a document presser, a detector, and device circuitry. The conveyor conveys the document placed on the document stacker. The reader reads the document conveyed by the conveyor. The document presser is movable between a contact position at which the document presser contacts the document placed on the document stacker and a retracted position at which the document presser is retracted from the document. The detector detects whether the document presser is present at one or both of the contact position and the retracted position. The server includes server circuitry that makes a determination based on a detection result of the document presser detected by the detector. The device circuitry performs control based on information indicating determination from the server circuitry.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an image forming apparatus;

FIG. 2 is a schematic diagram illustrating a configuration of a document conveying device;

FIG. 3A is a block diagram illustrating a configuration of a control unit of a document conveying device;

FIG. 3B is a diagram illustrating a functional configuration of a main control unit of an image forming apparatus;

FIG. 4 is a schematic plan view of a document conveying device;

FIG. 5 is a schematic plan view of a document conveying device;

FIGS. 6A and 6B are perspective views of a document conveying device;

FIGS. 7A to 7C are perspective views of a document conveying device;

FIGS. 8A and 8B are respectively a plan view and a side view of a document conveying device, illustrating the placement of a stack of mixed-size documents;

FIG. 9 is a diagram illustrating an image read by an image reading device;

FIG. 10 is a diagram illustrating another image read by an image reading device;

FIG. 11 is a diagram illustrating yet another image read by an image reading device;

FIG. 12 is a diagram illustrating an image read by an image reading device, in which a tilted document is corrected;

FIG. 13 is a flowchart of system control of an image forming apparatus;

FIG. 14 is a diagram illustrating a screen displayed on a control panel of an image forming apparatus;

FIG. 15 is a diagram illustrating a screen displayed on a control panel of an image forming apparatus;

FIG. 16 is a flowchart of a process performed by an image forming apparatus when a pressing plate is set while a mixed-size document reading mode is not set on a control panel;

FIG. 17 is a flowchart of a process performed by an image forming apparatus when a pressing plate is not set while a mixed-size document reading mode is set on a control panel;

FIG. 18 is a diagram illustrating a screen displayed on a control panel of an image forming apparatus;

FIG. 19 is a flowchart of a process performed by an image forming apparatus to display or not to display a button for setting a mixed-size document reading mode on a control panel when a pressing plate is not set on a document table;

FIG. 20 is a diagram illustrating a configuration of a main control unit and an artificial intelligence (AI) accelerator of an image forming apparatus;

FIG. 21 is a flowchart of a process for displaying a message on a control panel of an image forming apparatus;

FIG. 22A is a diagram illustrating a configuration of a main control unit of an image forming apparatus according to a first modification;

FIG. 22B is a diagram illustrating a configuration of main control units of an image forming apparatus connected to a server according to the first modification; and

FIG. 23 is a flowchart of a process for updating a trained model stored in a main control unit according to the first modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise. The term “connected/coupled” includes both direct connections and connections in which there are one or more intermediate connecting elements.

For the sake of simplicity, identical or similar reference numerals denote identical or similar elements such as parts and materials having the same functions, and redundant descriptions thereof are omitted unless otherwise required.

A document reading device, an image forming apparatus, and an image forming system are described in detail below with reference to the accompanying drawings.

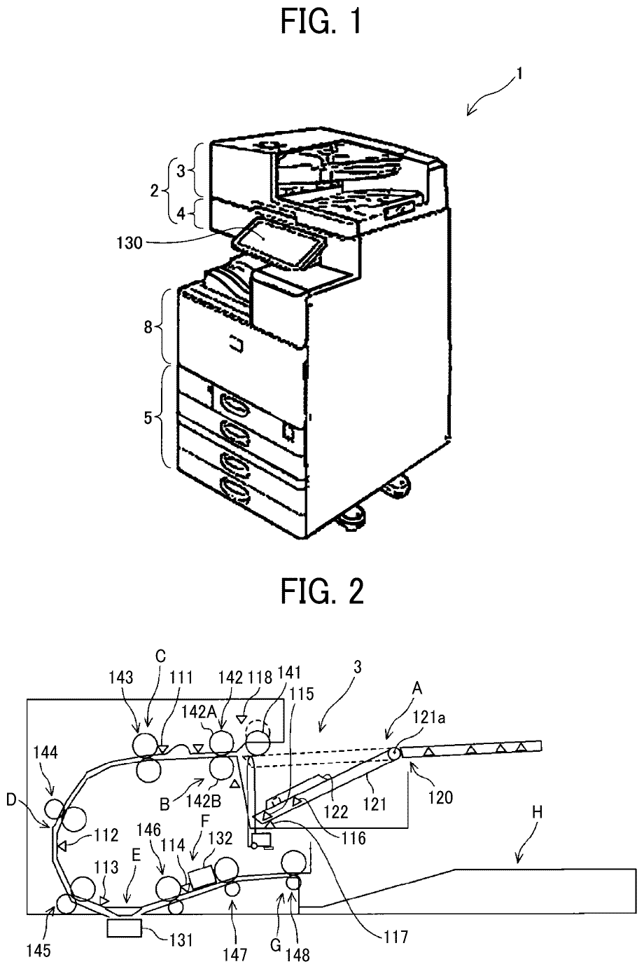

FIG. 1 is a perspective view of an image forming apparatus 1. As illustrated in FIG. 1, the image forming apparatus 1 has functions of, for example, a copier, a printer, a facsimile machine, and a scanner. The image forming apparatus 1 is capable of recording and outputting a full-color image or a monochrome image on a recording sheet in a predetermined data format based on input data such as read image data.

The image forming apparatus 1 includes a sheet feeding device 5, an image forming device 8, an image reading device 2, which is an example of a document reading device, and a control panel 130 as an operation display unit. The image reading device 2 includes a scanner 4 and a document conveying device 3, which is an automatic document feeder (ADF). The scanner 4 is an example of a reader that reads documents conveyed by the document conveying device 3. The control panel 130 is an example of an input device that receives user input for setting document reading conditions for the image reading device 2.

The sheet feeding device 5 includes multiple input trays to store cut recording sheets, and multiple sets of sheet feeding rollers to pick up and feed a recording sheet from a selected one of the input trays. The sheet feeding device 5 further includes a sheet feeding passage defined by various rollers and other components to convey the recording sheet fed from the selected input tray to a predetermined image forming position in the image forming device 8.

The image forming device 8 includes an exposure unit, multiple drum-shaped photoconductors, developing devices using four toners of cyan (C), magenta (M), yellow (Y), and black (K), an intermediate transfer device, a secondary transfer device, and a fixing device.

In the image forming device 8, for example, the exposure unit irradiates the photoconductors for the C, M, Y, and K colors to form electrostatic latent images thereon based on the image read by the image reading device 2. Developing units for the C, M, Y, and K colors of the developing device then apply toner to the corresponding latent images on the photoconductors to develop the latent images into visible toner images. The intermediate transfer device primarily transfers the toner images from the photoconductors for the C, M, Y, and K colors onto an intermediate transfer belt. The secondary transfer device secondarily transfers the toner images from the intermediate transfer belt onto a recording sheet such that the toner images are superimposed one atop another. The fixing device fixes the toner images, which have been secondarily transferred on the recording sheet, onto the recording sheet under heat and pressure. Thus, a color image is formed on the recording sheet. In other words, the image forming device 8 is an example of an image forming device that forms an image on a recording sheet, which is an example of a recording medium, based on an image read by the scanner 4.

Further, the image forming device 8 is capable of forming an external output image such as an image file or data that can be output to the outside, based on the image read by the scanner 4 or a second image reading unit, which will be described later.

Instead of the above-described electrophotographic image forming device 8, an image forming unit employing another recording method, such as an inkjet method, may be used.

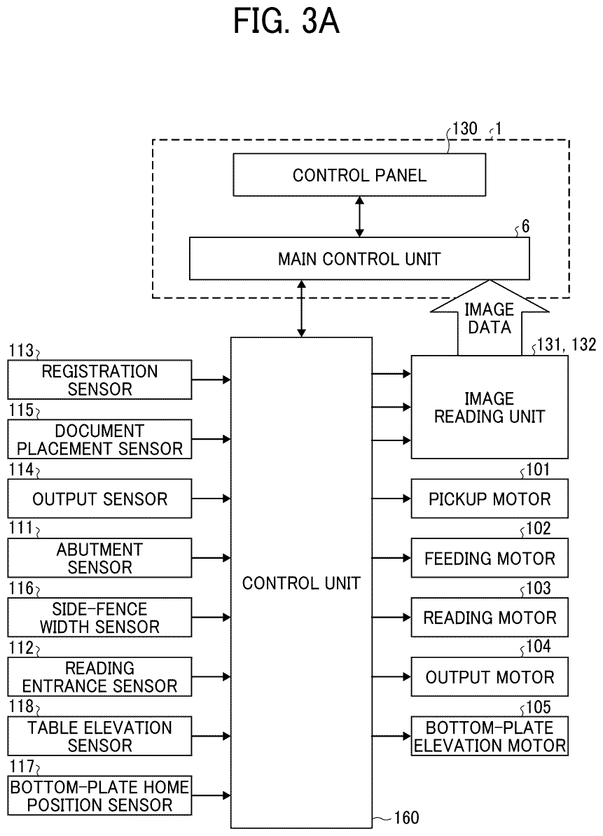

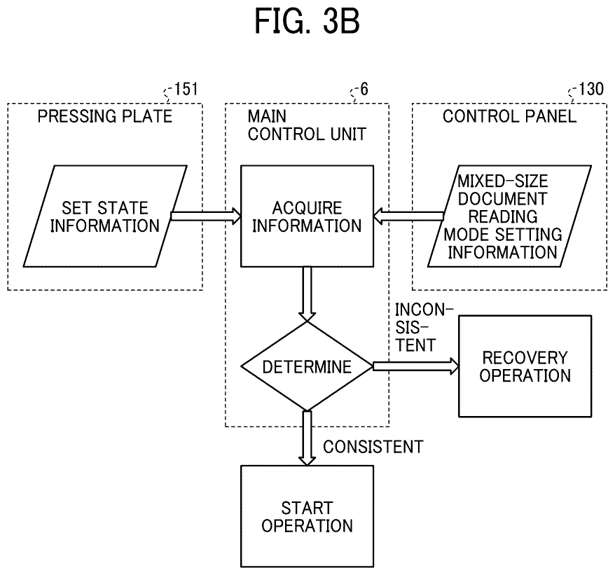

FIG. 2 is a schematic diagram illustrating a configuration of the document conveying device 3. FIG. 3A is a block diagram illustrating a configuration of a control unit of the document conveying device 3. FIG. 3B is a diagram illustrating a functional configuration of a main control unit of the image forming apparatus 1. The document conveying device 3 includes, as mechanical sections, a document placement section A, a separation feeding section B, a registration section C, a turning section D, a first reading and conveying section E, a second reading and conveying section F, an output section G, and a stacking section H. In the document placement section A, a stack of documents is placed. In the separation feeding section B, the documents are separated and fed one by one from the stack. In the registration section C, the fed document primarily abuts against rollers for alignment and the aligned document is drawn out and conveyed.

In the turning section D, the conveyed document is turned and further conveyed with a document surface facing downward in FIG. 2 to cause the document surface to face a reading side of a first image reading unit 131. In the first reading and conveying section E, the first image reading unit 131 reads a front image of the document from below a platen of the scanner 4. In the second reading and conveying section F, a second image reading unit 132 reads a back image of the document after the front image of the document is read. In the output section G, the document of which the front and back images have been read is output to the outside of the document conveying device 3. In the stacking section H, the output documents are stacked and held.

In the document placement section A, a single document or a stack of two or more documents, which are collectively referred to as “document stack” in the following description, is placed for reading. The document stack is placed on a document table 120, which serves as a document stacker and includes a movable table 121.

The document conveying device 3 is adjacent to the platen of the scanner 4. The document conveying device 3 is openable and closable via a hinge assembly so as to open and close the platen.

As illustrated in FIG. 3A, the document conveying device 3 includes a pickup motor 101, a feeding motor 102, a reading motor 103, an output motor 104, and a bottom-plate elevation motor 105, as five drivers that perform the driving for the document feeding operation (document conveying operation) in the above-described mechanical sections A to H, and a control unit 160 that includes circuits for controlling various operations, including the operations of the five drivers. In other words, the mechanical sections A to H and the five drivers are examples of conveyors that convey the documents from the document table 120.

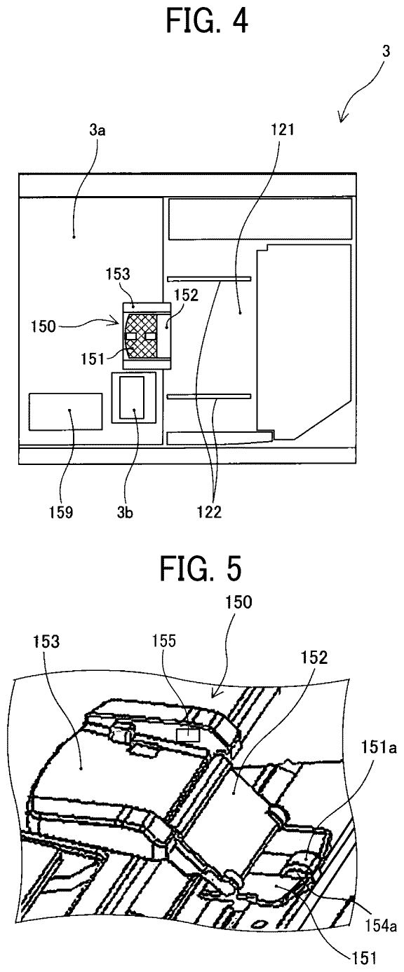

The control unit 160 supplies power to the components of the document conveying device 3. The control unit 160 also executes control for the components of the document conveying device 3 based on control signals transmitted from a main control unit 6, which is disposed in the main body of the image forming apparatus 1. As illustrated in FIG. 3B, the main control unit 6 acquires set state information and mixed-size document reading mode setting information. The set state information indicates a usage state of a pressing plate 151 (see, for example, FIG. 4) in the document conveying device 3. In other words, the set state information indicates whether the pressing plate 151 is at a usage position or a storage position in the document conveying device 3. The mixed-size document reading mode setting information indicates whether the reading operation mode of the image reading device 2 is set to a mixed-size document reading mode. Then, the main control unit 6 initiates a recovery operation or document conveying and reading operations, depending on whether the usage state of the pressing plate 151 is consistent with the reading operation mode. The mixed-size document reading mode may be a mode for reading irregularly shaped documents of different widths, or documents of different sizes and widths, placed on the document table 120. In other words, the main control unit 6 is an example of circuitry that performs control based on the detection results of the pressing plate 151 detected by a detector 155 (see FIG. 5). This can further enhance operability when conveying documents of mixed sizes. Specifically, the main control unit 6 can determine whether the image forming apparatus 1 is ready for a mixed-size document reading operation, which is an operation for detecting document edges to determine document size and correct skew, based on the state of the pressing plate 151 of the document conveying device 3, without leaving the operation setting to the user.

To read a document image, a document stack is placed on a document stacker, namely, the document table 120 including the movable table 121, with the document face, which is the first side, facing up. In other words, the document table 120 is an example of a document stacker on which one or more documents are placed or stacked. Further, the width direction of the document stack, which is a direction perpendicular to a document conveying direction in which documents are conveyed, is restricted by side fences 122 as a restricting member. The side fences 122 are positioned (aligned) according to the width of the document stack. The positions of the aligned side fences 122 are detected by a side-fence width sensor 116. Thus, the width of the document stack can be detected. The movable table 121 is provided with a document placement sensor 115, which detects that the document stack is placed, that is, the placement state of the document stack. The detection result is transmitted from the document placement sensor 115 to the main control unit 6 via an interface (I/F).

The movable table 121 is supported such that the trailing end of the movable table 121, which is positioned downstream in a document feeding direction in which documents are fed, is pivotable about a pivot shaft 121a. The movable table 121 is pivotable about the pivot shaft 121a by the bottom-plate elevation motor 105, thereby enabling the leading end of the movable table 121, which is positioned upstream in the document feeding direction, to move up and down.

Before documents are placed on the document table 120, the movable table 121 of the document table 120 is positioned at a home position, which may be referred to as a lower position. With the movable table 121 at the home position, the user places a document stack on the document table 120. At this time, the uppermost surface of the document stack on the movable table 121 at the home position is in a separated state apart from a pickup roller 141.

When the document placement sensor 115 detects that documents are placed, the control unit 160 rotates the bottom-plate elevation motor 105 forward to raise the movable table 121. A table elevation sensor 118 detects that the pickup roller 141, serving as a feeding member, is pushed up by the upper surface of the document stack on the movable table 121 when the movable table 121 moves up.

In response to a detection signal, the control unit 160 stops driving the bottom-plate elevation motor 105 to stop the movable table 121 at the proper position.

In other words, the table elevation sensor 118 is a sensor that detects that the movable table 121 has reached a proper position and holds the upper surface of the document stack at a proper feeding height. Specifically, when the table elevation sensor 118 is turned on, elevation of the movable table 121 is stopped. After that, when documents are repeatedly fed and the upper surface position of the document stack lowers, causing the table elevation sensor 118 to turn off, the movable table 121 is raised again. Then, when the table elevation sensor 118 is turned on again, elevation of the movable table 121 is stopped. Repeating the above-described control operation holds the upper surface position of the document stack, which is the height of the uppermost document, within a height range suitable for document feeding.

Although the movable table 121 is moved up and down in the present example, a pickup roller may be moved up and down whereas a table is stationary in another example. Alternatively, the lowermost document of the document stack placed on a table may be fed by a feeding member. In this case, an elevatable pickup roller, which is disposed below a stationary table, enters an opening or cutout of the table from below to contact the lowermost surface of the document stack on the table.

Alternatively, the table may be moved up integrally with the pickup roller, which projects beyond the table and contacts the lowermost surface of the document stack, to cause the uppermost surface of the document stack to contact an upper-surface restricting member, allowing the lowermost surface of the document stack placed on the table to be fed by the feeding member. Alternatively, the table and the pickup roller that projects beyond the table may remain stationary while the upper-surface restricting member moves down to contact the uppermost surface of the document stack, allowing the lowermost surface of the document stack to be fed by the feeding member. In this case, a contact state in which the pickup roller is in contact with a document refers to a condition in which the uppermost surface of the document stack is in contact with the upper-surface restricting member, and the pickup roller applies sufficient contact pressure to properly feed the document. By contrast, a separated state in which the pickup roller is apart from a document refers to a condition in which the uppermost surface of the document stack is not in contact with the upper-surface restricting member, and the pickup roller applies only light contact pressure, resulting in slippage and failure to properly feed the document.

When all the documents of the document stack placed on the document table 120 are fed, the document placement sensor 115 is turned off. When the document placement sensor 115 is turned off, the control unit 160 reverses the bottom-plate elevation motor 105 to lower the movable table 121 to the home position so that the next document stack can be placed on the document table 120. A bottom-plate home position sensor 117 is disposed to detect that the movable table 121 is at the home position, allowing the control unit 160 to confirm whether the movable table 121 is at the home position.

When a document reading instruction operation, which may be referred to as a feeding start instruction, is performed on the control panel 130 while the pickup roller 141 is in contact with the uppermost surface of the document stack on the movable table 121, a document feeding signal, which may be referred to as a feeding start signal, is transmitted from the main control unit 6 to the control unit 160 via the interface. As a result, the feeding operation begins. While the upper surface of the document stack on the movable table 121 is maintained at the optimal height for feeding, the feeding motor 102 rotates forward, turning the pickup roller 141, which then picks up one or more sheets—ideally a single sheet—from the document stack on the document table 120. At this time, the direction of rotation is the direction for conveying the uppermost document forward in the document feeding direction.

A separation roller pair 142 includes a feeding roller 142A and a reverse roller 142B facing the feeding roller 142A. The feeding roller 142A is rotated in the document feeding direction by the forward rotation of the feeding motor 102, whereas the reverse roller 142B is rotated in a direction opposite to the document feeding direction by the forward rotation of the feeding motor 102.

A single document separated from other documents by the separation roller pair 142 is further conveyed by the feeding roller 142A and the leading end of the document is detected by an abutment sensor 111. The document is further conveyed and abuts against a still pull-out roller pair 143. The document is further conveyed a predetermined distance from the detection timing of the abutment sensor 111, resulting in the leading end of the document being pressed against the pull-out roller pair 143 with a specified amount of bending. Under these conditions, the feeding motor 102 stops thereby stopping the driving of the feeding roller 142A conveying the document.

The control unit 160 rotates the pickup motor 101 and retracts the pickup roller 141 from the upper surface of the document stack when the leading end of the document is detected by the abutment sensor 111. In other words, the document is fed solely by the conveying force of the feeding roller 142A of the separation roller pair 142. The above-described operation allows the leading end of the document to enter the nip portion of the pull-out roller pair 143, where the leading end of the document is aligned, that is, the skew of the document is corrected. The pull-out roller 143 has a skew correction function and conveys the document, which has undergone skew correction after separation, to an intermediate roller 144. The pull-out roller pair 143 is driven by the reverse rotation of the feeding motor 102. During the reverse rotation of the feeding motor 102, the pull-out roller pair 143 and the intermediate roller 144 are driven, whereas the pickup roller 141 and the feeding roller 142A are not driven.

The length of the document in the document conveyance direction can be determined based on motor pulses by detecting the leading and trailing ends of the document with the abutment sensor 111. The document is conveyed from the registration section C to the turning section D by the driving of the pull-out roller pair 143 and the intermediate roller 144. At this time, the conveyance speed in the registration section C is set to be higher than the conveyance speed in the first reading and conveying section E. This setting can shorten the processing time for feeding the document to the first reading and conveying section E. When the leading end of the document is detected by a reading entrance sensor 112, deceleration is initiated to match the conveyance speed for conveying the document with the reading conveyance speed before the leading end of the document enters the nip portion of a reading entrance roller pair 145. At the same time, the reading motor 103 is driven in forward rotation to drive the reading entrance roller pair 145, a first reading exit roller 146, and a second reading exit roller 147.

When a registration sensor 113 detects the leading end of the document, the control unit 160 temporarily stops the document immediately before the first reading and conveying section E and transmits a temporary stop signal to the main control unit 6 via the interface. In response to a reading start signal from the main control unit 6, the control unit 160 accelerates the conveyance so that the conveyance speed rises to a predetermined speed by the time the leading end of the document, which has been temporarily stopped, reaches the first reading and conveying section E. The control unit 160 transmits a gate signal, indicating an effective image area in a sub-scanning direction of the first side, to the first image reading unit 131 at the time when the leading end of the document detected by the pulse count of the reading motor 103 reaches the first reading and conveying section E.

The gate signal is transmitted until the trailing end of the document exits the first reading and conveying section E.

In the case of single-sided reading, the document that has passed through the first reading and conveying section E is conveyed to the output section G through the second reading and conveying section F. At this time, the control unit 160 drives the output motor 104 in the forward rotation to rotate an output roller pair 148 when an output sensor 114 detects the leading end of the document. The control unit 160 counts the pulses of the output motor 104 after the output sensor 114 detects the leading end of the document. The control unit 160 decelerates the driving speed of the output motor 104 immediately before the trailing end of the document exits the nip portion of the output roller pair 148, thereby preventing the document to be ejected onto an output tray in the stacking section H from being ejected uncontrollably.

In the case of duplex reading, the control unit 160 detects the leading end of the document that has passed through the first reading and conveying section E with the output sensor 114, and then counts the pulses of the reading motor 103. The control unit 160 then transmits a gate signal, indicating an effective image area in the sub-scanning direction, to the second image reading unit 132 at the time when the leading end of the document reaches the second reading and conveying section F. The gate signal is transmitted until the trailing end of the document exits the second reading and conveying section F. After that, the document that has passed through the second reading and conveying section F is conveyed to the output section G.

A stack of documents of mutually different widths, which may be referred to as a mixed-size document stack in the following description, may be placed on the document table 120. At this time, the maximum-width document in the mixed-size document stack can be placed at a desired position in the width direction through restriction by the side fences 122. Specifically, the maximum-width document can be placed such that the widthwise center thereof aligns with the widthwise center of the conveyance passage, which may be referred to as a conveyance reference position in the following description.

However, the side fences 122 fail to position documents other than the maximum-width document in the mixed-size document stack such that the widthwise center of each document aligns with the conveyance reference position. Therefore, it has been difficult to align the widthwise center of documents other than the maximum-width document with the conveyance reference position.

Further, since documents other than the maximum-width document are fed without being restricted in the width direction by the side fences 122, the document are susceptible to instability in posture and skewing. Especially, small, thin, and lightweight documents are susceptible to instability in posture during feeding. As a result, the documents may be skewed. To address such a situation, a pressing assembly presses a mixed-size document stack placed on the document table 120 and indicates the placement position of the documents in the width direction in the present embodiment.

FIG. 4 is a schematic plan view of the document conveying device 3. FIG. 4 illustrates the document conveying device 3 when a pressing assembly 150 is not in use. FIG. 5 is a schematic plan view of the document conveying device 3. FIG. 5 illustrates the document conveying device 3 when the pressing plate 151 of the pressing assembly 150 is used.

The pressing assembly 150 is located at the widthwise center of an upstream end, in the document conveying direction, of the upper surface of a sheet feeding cover 3a of the document conveying device 3. An operation lever 3b for opening the sheet feeding cover 3a is positioned closer to the front side of the document conveying device 3 than the pressing assembly 150. This arrangement allows the user to operate the operation lever 3b without the pressing assembly 150 obstructing the operation of the operation lever 3b.

As illustrated in FIG. 5, the pressing assembly 150 includes the pressing plate 151 as a pressing member, an arm 152, a housing 153, and the detector 155. The arm 152 pivotally supports the pressing plate 151 and is pivotally supported by the housing 153.

The movable table 121 of the document table 120 is inclined at different angles during document placement and document feeding. As the pressing plate 151 is pivotally supported by the arm 152, the pressing plate 151 can follow the changes in the angle of inclination of the movable table 121. Further, as the pressing plate 151 is pivotally supported by the arm 152, the pressing plate 151 can be stored in the housing 153 such that the pressing plate 151 is folded over the arm 152. Such a configuration allows the pressing assembly 150 to be compact when the pressing plate 151 is not in use. In other words, the pressing plate 151 is an example of a document presser that is movable between a contact position at which the pressing plate 151 contacts a document placed on the document table 120 and a retracted position at which the pressing plate 151 is retracted from the document placed on the document table 120. The detector 155 is an example of a detector that detects whether the pressing plate 151 is present at one or both of the contact position and retracted position.

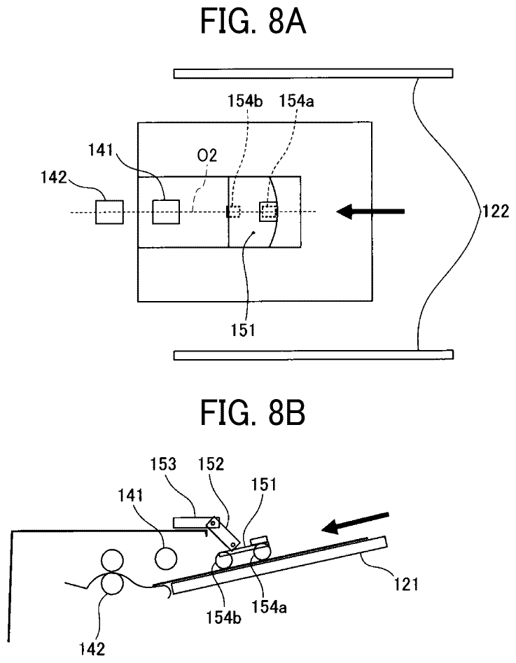

The pressing plate 151 includes pressure rollers 154a and 154b (see FIGS. 8A and 8B) as pressure members. The pressure rollers 154a and 154b are pivotally supported at the widthwise center. The pressing plate 151 further includes a convex cover 151a that covers the pressure roller 154a, which is supported pivotally upstream in the document conveying direction, at the widthwise center of an upstream portion of the pressing plate 151 in the document conveying direction. In the present embodiment, the convex cover 151a has the function of aligning the widthwise center of each document with the conveyance reference position.

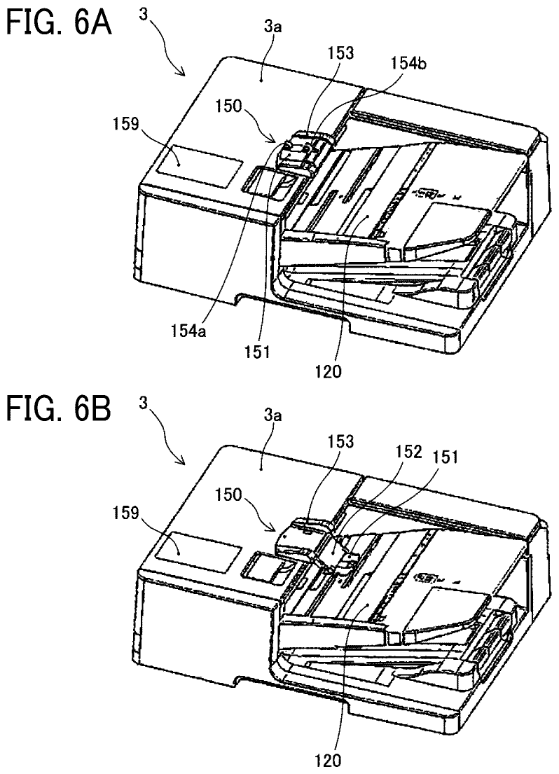

FIGS. 6A and 6B are perspective views of the document conveying device 3. As illustrated in FIG. 6A, when the pressing plate 151 is not in use, the arm 152 and the pressing plate 151 are folded over one another and stored in the housing 153. The pressing plate 151 is stored in the housing 153 such that the surface that faces the placement surface of the document table 120 when the pressing plate 151 is in use faces upward in the housing 153.

In this way, when the pressing plate 151 is not in use, the pressing plate 151 is positioned at the storage position (retracted position) on the sheet feeding cover 3a, thereby preventing the pressing plate 151 from interfering during placement of the document stack. The storage position (retracted position) is a second position where the pressing plate 151 is retracted from a first position adjacent to the document on the document table 120.

To use the pressing plate 151, the pressing plate 151 stored in the housing 153 is lifted and pivoted approximately 180° for deployment. As illustrated in FIG. 6B, the pressure rollers 154a and 154b (see FIGS. 8A and 8B) of the pressing plate 151 are brought into contact with the placement surface of the document table 120. As a result, the pressing plate 151 is positioned at a usage position (contact position), which is the first position adjacent to the document on the document table 120.

A display label 159 serving as instruction means for indicating how to use the pressing plate 151 is affixed to the upper surface of the sheet feeding cover 3a. The display label 159 instructs that the pressing plate 151 should be positioned at the usage position illustrated in FIG. 6B when the mixed-size document stack is placed on the document table 120. The display label 159 also instructs that the document should be placed such that the widthwise center of the document aligns with the widthwise center of the pressing plate 151 with the convex cover 151a of the pressing plate 151 serving as a pressing part.

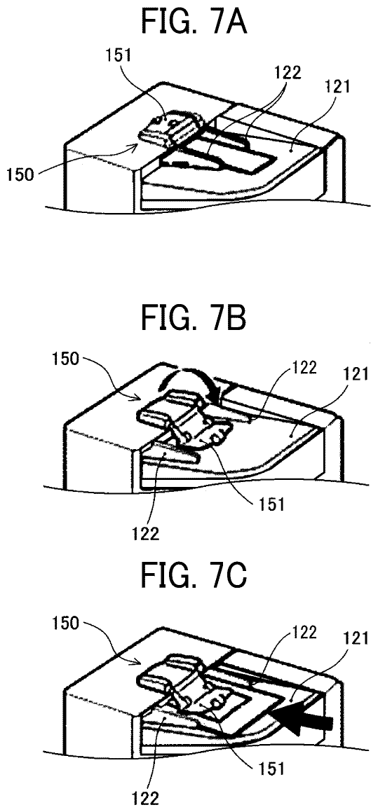

FIGS. 7A to 7C are perspective views of the document conveying device 3. As illustrated in FIG. 7A, when a user places a document stack of the same width, the user may restrict the widthwise ends of the document stack with the side fences 122 to align the widthwise center of the document stack with the conveyance reference position, which is the desired position. Since such a configuration renders the pressing plate 151 unnecessary at this time, the pressing plate 151 is retracted from the document table 120 into the housing 153. As a result, the pressing plate 151 does not interfere with the placement of the document stack on the document table 120 by the user, thereby enabling easy positioning of the document on the document table 120.

As illustrated in FIG. 7B, when a user places a mixed-size document stack, which is a stack of documents of mutually different widths, the pressing plate 151 is moved from the storage position at which the pressing plate 151 is stored in the housing 153 to the usage position adjacent to the document table 120.

When the pressing plate 151 is positioned at the usage position, as illustrated in FIG. 7C, the documents in the mixed-size document stack are inserted sequentially, starting from the lowermost document, between the pressing plate 151 and the document table 120 in the document conveying direction as indicated by arrow in FIG. 7C. At this time, the pressure rollers 154a and 154b, which are pivotally supported by the pressing plate 151, accompany the inserted document and smoothly insert the document between the pressing plate 151 and the document table 120.

FIGS. 8A and 8B are respectively a plan view and a side view of the document conveying device 3, illustrating the placement of a mixed-size document stack. Specifically, FIG. 8A is a plan view of the document conveying device 3, illustrating the placement of a mixed-size document stack. FIG. 8B is a side view of the document conveying device 3, illustrating the placement of the mixed-size document stack.

As illustrated in FIGS. 8A and 8B, a user inserts a document between the pressing plate 151 and the document table 120 in the document conveying direction. After inserting the document, document alignment is performed by moving the document in the width direction such that the widthwise center of the convex cover 151a aligns with the widthwise center of the document and that the amount by which the document projects from both widthwise ends of the pressing plate 151 is equal. Thus, the widthwise center of the document can be aligned with a conveyance reference position O2. Once the document alignment is complete, the user inserts the next document between the pressing plate 151 and the document table 120 in the document conveying direction. In this way, the user can place a mixed-size document stack.

After inserting all the documents of the mixed-size document stack between the pressing plate 151 and the document table 120, the user moves the side fences 122 in the width direction so that the side fences 122 contact the widthwise ends of a document having the greatest width in the mixed-size document stack. This completes the placement of the mixed-size document stack. Once the mixed-size document stack has been placed, the user operates the control panel 130 to start conveying the documents in a mixed-size mode.

The feeding of the documents in the mixed-size mode is slower in speed than the feeding of documents in a normal mode, which is set when a stack of documents having the same width are set as described above with reference to FIG. 7A.

Documents other than the document having the greatest width in the mixed-size document stack are not restricted in the width direction by the side fences 122. For this reason, the widthwise movement of documents being fed may move documents other than the document having the greatest width on the document table 120, gradually misaligning the documents.

Feeding a document at the feeding speed used in the normal mode generates greater kinetic energy, resulting in a stronger force exerted by a document being fed on a document prior to feeding on the document table 120, thereby increasing the likelihood that the document prior to feeding on the document table 120 is moved.

Reducing the feeding speed in the mixed-size mode to be slower than the feeding speed in the normal mode suppresses the force exerted by the document being fed on the document prior to feeding on the document table 120. This can prevent misalignment of the documents other than the document having the greatest width on the document table 120 from being disturbed. As a result, for example, the occurrence of feeding failures is reduced.

The documents other than the document having a maximum width in the mixed-size document stack are fed without being restricted in the width direction by the side fences 122, and be more susceptible to skewing than the document having a maximum width. In the present embodiment, the documents are fed while being pressed by the two pressure rollers 154a and 154b of the pressing plate 151. The pressure exerted by the pressure rollers 154a and 154b can prevent the documents from skewing (inclining) during feeding. The widthwise centers of the pressure rollers 154a and 154b are positioned at the conveyance reference position O2, and are arranged in a straight line with the pickup roller 141 and the separation roller pair 142 along the conveyance direction, as illustrated in FIG. 8A. This arrangement can prevent the application of force in the width direction to the document during feeding, thereby favorably preventing the occurrence of skew. Since the pressure rollers 154a and 154b accompany the fed document, the pressure rollers 154a and 154b can prevent the rubbing of the document and reduce the wear of the document.

A feature of the image forming apparatus 1 is described below. The image forming apparatus 1 has the function of recognizing a document sheet edge line from an image that is obtained by reading, with the scanner 4 of the image forming apparatus 1, the document conveyed by the document conveying device 3 to determine document size and correct document skew.

Various techniques are known for recognizing a document sheet edge line. One such technique involves utilizing the image density difference between the document and the background. In this method, the background is rendered either black or white so as to enhance the contrast with the document, thereby facilitating detection of the sheet end. Another technique involves irradiating the background surface with near-infrared (NIR) light to convert the background to black. The boundary line between the document and the background is then detected based on the resulting density difference.

Once document edges are detected, image processing can be performed to crop the read image to match the size of the document, or to correct any skew if the image is tilted. By employing such techniques, documents of various sizes can be read simultaneously in a single operation.

For the mixed-size document reading operation, the user sets the mixed-size document reading mode on the control panel 130 of the image forming apparatus 1. In the mixed-size document reading operation, the document size detection and skew correction are performed for each individual read document, resulting in increased processing time. Since the mixed-size document reading operation differs from reading operations for reading regular-sized documents under normal operating conditions, the mixed-size document reading operation requires a separate mode setting.

Specifically, in the mixed-size document reading operation, documents of various sizes are first placed on the document table 120 of the document conveying device 3. The pressing plate 151 is mounted on the sheet feeding cover 3a above the document table 120 of a document conveying device 3. The pressing plate 151 stabilizes the conveyance of documents in the document conveying device 3. Specifically, the pressing plate 151 presses the placed document from above to prevent the document from wobbling while being conveyed and keep the conveyance stable. Since the pressing plate 151 is mounted at the center position of the document conveyance passage, the pressing plate 151 also serves as an indicator for placing the document at the conveyance center position.

The pressing plate 151 is stored in a base on the sheet feeding cover 3a of the document conveying device 3 when the pressing plate 151 is not in use. To use the pressing plate 151, the pressing plate 151 at the end is opened, which is detectable by the detector 155. The detector 155 can be implemented through digital detection using an electrically operated switch or sensor. With the detector 155, the system recognizes that the user has placed the document for the mixed-size document reading operation on the document table 120 of the document conveying device 3, determines the compatibility with the previous reading operation mode setting, which is the setting of the mixed-size document reading mode on the control panel 130, and initiates the mixed-size document reading operation. When the user forgets to set the reading operation mode on the control panel 130 or to set the pressing plate 151, the image forming apparatus 1 can detect an inconsistency in operation.

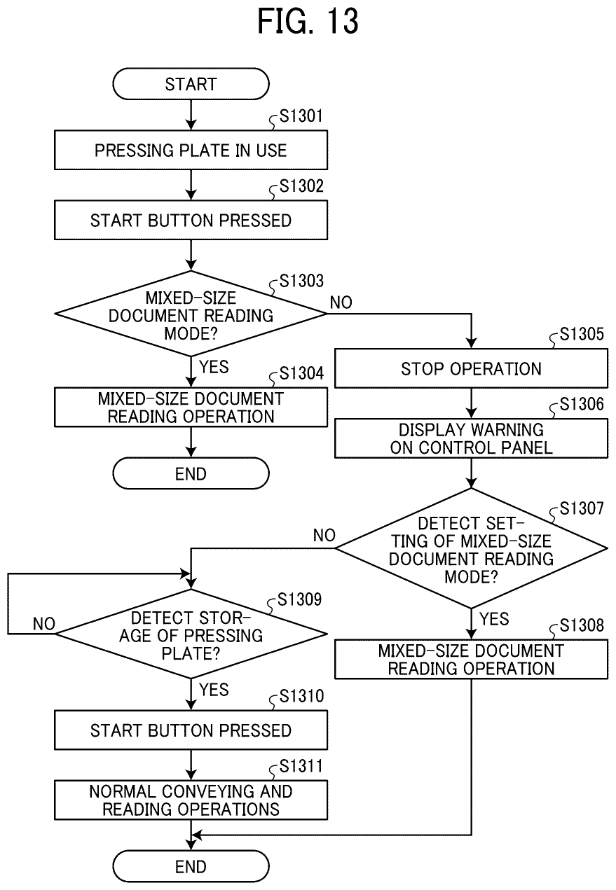

For the mixed-size document reading operation, when the user places documents of various sizes on the document table 120 of the document conveying device 3, sets the pressing plate 151, and presses a document reading start button without setting the mixed-size document reading mode on the control panel 130, the main control unit 6 detects an inconsistency in the operation settings between the reading operation mode set on the control panel 130 and the set state of the pressing plate 151 indicating whether the pressing plate 151 is set. In this case, for example, the main control unit 6 does not initiate the reading operation and displays, on the control panel 130, a warning indicating that the mixed-size document reading mode is not set. The main control unit 6 initiates the reading operation in response to detection of the setting of the mixed-size document reading mode on the control panel 130. A detailed description thereof is given later with reference to FIG. 13.

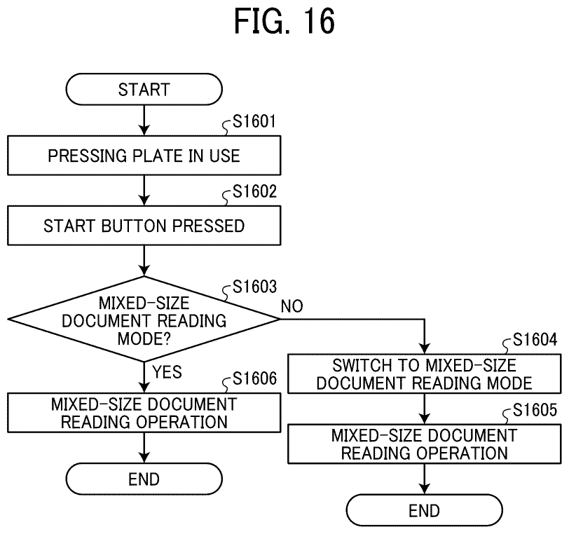

Alternatively, as described in detailed below with reference to FIG. 16, the main control unit 6 may determine to perform operation in the mixed-size document reading mode because the pressing plate 151 of the document conveying device 3 is set, and initiates the operation after changing the operating mode to the mixed-size document reading mode.

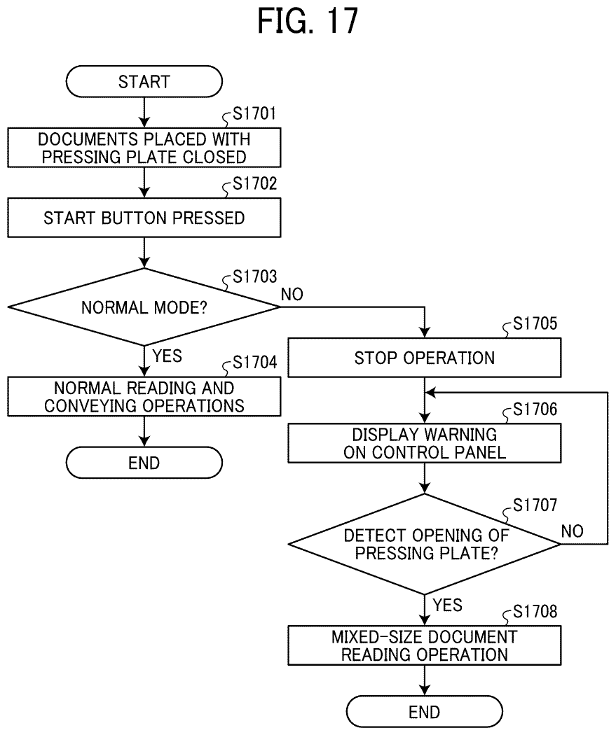

For the mixed-size document reading operation, when the user places documents of various sizes on the document table 120 of the document conveying device 3, sets the mixed-size document reading mode on the control panel 130 without setting the pressing plate 151 disposed on the document conveying device 3, and presses the document reading start button, the main control unit 6 detects an inconsistency in the operation settings between the reading operation mode set on the control panel 130 and the set state of the pressing plate 151. In this case, for example, the main control unit 6 does not initiate the reading operation and displays, on the control panel 130, a warning indicating that the pressing plate 151 on the document conveying device 3 is not set. The main control unit 6 initiates the reading operation when the detector 155 detects that the pressing plate 151 is set on the document conveying device 3. A detailed description thereof is given later with reference to FIG. 17.

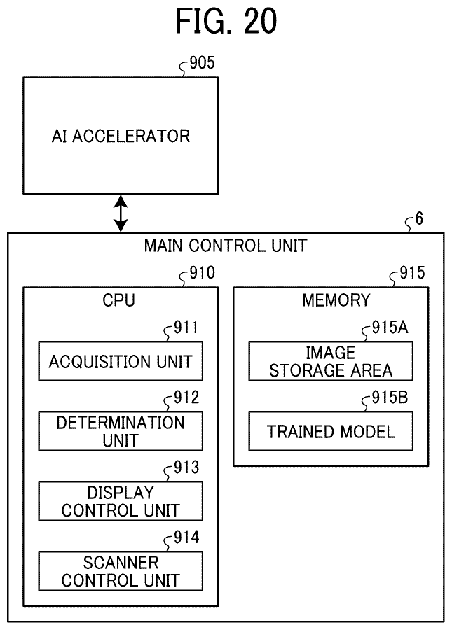

Alternatively, when the pressing plate 151 disposed on the document conveying device 3 is not set, the main control unit 6 may determine that the button for setting the mixed-size document reading mode is not displayed on the control panel 130 and therefore is unavailable. In this case, once the detector 155 detects that the pressing plate 151 disposed on the document conveying device 3 is set, the button for setting the mixed-size document reading mode is displayed on the control panel 130, allowing the user to set the mixed-size document reading mode. A detailed description thereof is given later with reference to FIG. 20.

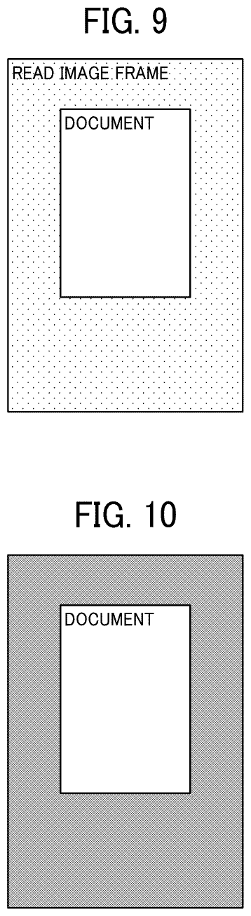

FIG. 9 is a diagram illustrating an image read by the image reading device 2. An image read by the image reading device 2 is inside a read image frame as illustrated in FIG. 9. For this reason, the boundary line between the read image frame and the document edges (i.e., sheet edge line) may be detected based on the image density difference between the read image frame and the document.

FIG. 10 is a diagram illustrating another image read by the image reading device 2. As illustrated in FIG. 10, an image read by the image reading device 2 may have a black background, which increases the difference in image density between the background and the document and facilitates clear identification of the boundary line between the background and the document edges.

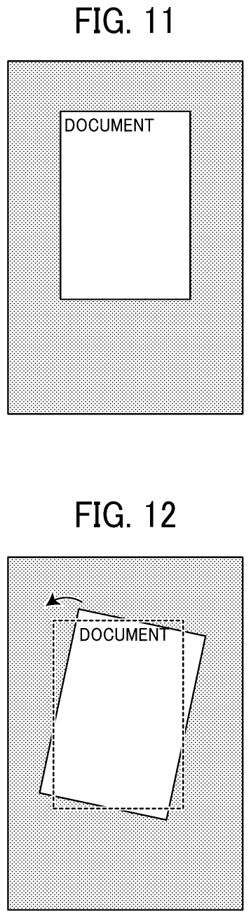

FIG. 11 is a diagram illustrating yet another image read by the image reading device 2. As illustrated in FIG. 11, an image read by the image reading device 2 may have a dark-colored background that is produced by irradiating a white background plate with NIR light to convert the background to a dark color. Such a dark-colored background facilitates clear identification of the boundary line between the background and the document edges.

FIG. 12 is a diagram illustrating an image read by the image reading device 2, in which a tilted document is corrected. Since images read by the image reading device 2 according to the present embodiment and modified example enables clear identification of the boundary line between the background and the document edges, the tilt of the read document can be corrected by image processing as illustrated in FIG. 12.

FIG. 13 is a flowchart of system control of the image forming apparatus 1. Specifically, FIG. 13 illustrates a flow of operations when a pressing member (the pressing plate 151) is set while the mixed-size document reading mode is not set on the control panel 130. When the pressing member (the pressing plate 151) is opened and set on the upper surface of a mixed-size document stack as illustrated in FIGS. 8A and 8B, the detector 155 (see FIG. 5) no longer detects the pressing plate 151. As a result, in step S1301, the main control unit 6 determines that the pressing plate 151 has moved from the storage position to the usage position. The mixed-size document reading mode (mixed-size mode) may be a mode for reading a mixed-size document stack, including irregularly shaped documents of different widths or documents of different sizes and widths, placed on the document table 120.

In step S1302, a start button is pressed on the control panel 130 by a user. In step S1303, the main control unit 6 determines the reading operation mode. When the mixed-size document reading mode is set (YES in step S1303), in step S1304, the main control unit 6 causes the image reading device 2 to initiate the conveying and reading operations in the mixed-size document reading mode. Although conveying documents of different sizes tends to be unstable in the document conveying device 3, the documents can be conveyed at a slow speed to enable stable conveyance and image reading through the conveying and reading operations in the mixed-size document reading mode. In other words, the main control unit 6 controls the conveying operation of the document conveying device 3 based on the reading conditions set through the control panel 130, such as the setting of the mixed-size document reading mode, and the detection result of the pressing plate 151 detected by the detector 155.

By contrast, when the start button is pressed on the control panel 130 by the user in step S1302 and the main control unit 6 determines that mixed-size document reading mode is not set (NO in step S1303), in step S1305, the main control unit 6 causes the image reading device 2 to stop the document conveying and reading operations.

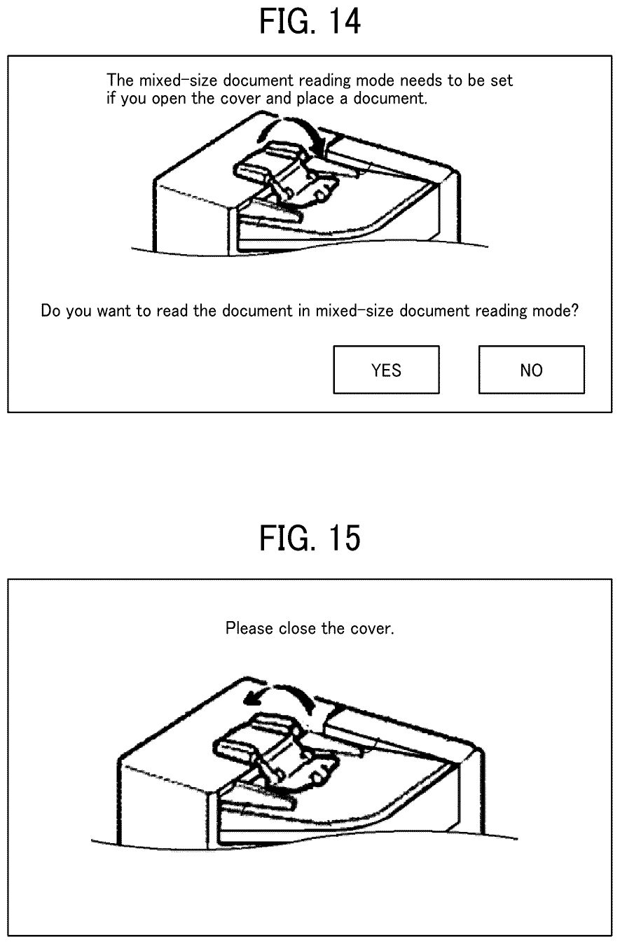

In step S1306, the main control unit 6 displays a warning indicating that the mode is not set on the control panel 130, as illustrated in FIG. 14. The main control unit 6 can recognize whether the user intends to cause the image forming apparatus 1 is to perform the conveying and reading operations in the mixed-size document reading mode, based on the open/closed state of the pressing plate 151 of the document conveying device 3, specifically, based on whether the pressing plate 151 is at the usage position or the storage position. For this reason, when the user forgets to set the reading operation mode on the control panel 130, the user can determine an inconsistency between the reading operation mode and the open/closed state of the pressing plate 151 by checking the display on the control panel 130. In other words, the main control unit 6 outputs to the control panel 130, which is an example of a display, a prompt indicating that the location of the pressing plate 151 or the reading conditions, such as the setting of the mixed-size document reading mode, is to be changed.

In step S1307, the main control unit 6 determines whether the reading operation mode is set to the mixed-size document reading mode. To read documents in the mixed-size document reading mode, the user presses “YES” on the screen displayed on the control panel 130 as illustrated in FIG. 14. As a result, the main control unit 6 detects that the reading operation mode is set to the mixed-size document reading mode (YES in step S1307). In step S1308, the main control unit 6 causes the image reading device 2 to initiate the document conveying and reading operations in the mixed-size document reading mode. By contrast, to read documents in the normal mode, the user presses “NO” on the screen displayed on the control panel 130 as illustrated in FIG. 14. As a result, the main control unit 6 detects that the reading operation mode is set to the normal mode (NO in step S1307). Subsequently, the main control unit 6 displays, on the control panel 130, a screen instructing the user to close the pressing plate 151 as illustrated in FIG. 15. In step S1309, the main control unit 6 determines whether the pressing plate 151 is closed (stored) based on a result of detection by the detector 155. When the main control unit 6 determines that the pressing plate 151 is not closed (NO in step S1309), the main control unit 6 repeats the determination in step S1309. By contrast, when the main control unit 6 determines that the pressing plate 151 is closed (YES in step S1309) and the start button is pressed on the control panel 130 by the user (step S1310), in step S1311, the main control unit 6 initiates the document conveying and reading operations in the normal mode.

The example illustrated in FIG. 13 prevents the documents from being conveyed at the normal speed when the user forgets to set the appropriate reading operation mode while opening and setting the pressing plate 151 on the upper surface of mixed-size documents. As a result, conveyance failures in the document conveying device 3 are also prevented. In the reading of mixed-size documents under NIR light (modified example), the processing is performed at a timing and a conveyance speed different from those for the reading operations under normal operating conditions. Accordingly, the modified example prevents images with excessive margins resulting from unsuccessful cropping, truncated images, and images that remain tilted (some of which are truncated while being tilted), which may be produced when the user forgets to set the reading operation mode and therefore the documents are read in the reading operations under normal operating conditions.

On the other hand, when the user sets the pressing plate 151 on the document conveying device 3, sets the mixed-size document reading mode on the control panel 130, places regular-sized documents, and starts reading operations, the documents are read under NIR light in the mixed-size document reading mode, causing no particular unfavorable circumstances.

FIG. 16 is a flowchart of a process performed by the image forming apparatus 1 when the pressing plate 151 is set while the mixed-size document reading mode is not set on the control panel 130. The example illustrated in FIG. 16 is different from the example illustrated in FIG. 14 in that the reading operation mode is changed to the mixed-size document reading mode based on internal determination.

In step S1601, the main control unit 6 determines that the pressing plate 151 is opened and positioned at the usage position. In step S1602, the start button is pressed on the control panel 130 by the user. In response, the main control unit 6 acquires the setting details of the reading operation mode. In step S1603, the main control unit 6 determines the reading operation mode. When the mixed-size document reading mode is not set (NO in step S1603), in step S1604, the main control unit 6 switches the reading operation mode to the mixed-size document reading mode. In step S1605, the main control unit 6 executes the document conveying and reading operations in the mixed-size document reading mode. According to the example illustrated in FIG. 16, when the pressing plate 151 is opened and set on the upper surface of mixed-size documents, the main control unit 6 executes the document conveying and reading operations in the mixed-size document reading mode, thereby achieving effects similar to those of the example illustrated in FIG. 14. By contrast, when the mixed-size document reading mode is set (YES in step S1603), in step S1606, the main control unit 6 executes the document conveying and reading operations in the mixed-size document reading mode. In other words, when the detector 155 does not detect the pressing plate 151 and the reading conditions are not set to the reading conditions associated with use of the pressing plate 151, that is, the reading operation mode is not set to the mixed-size document reading mode, the main control unit 6 executes the document conveying and reading operations under the reading conditions associated with the use of the pressing plate 151.

FIG. 17 is a flowchart of a process performed by the image forming apparatus 1 when the pressing plate 151 is not set while the mixed-size document reading mode is set on the control panel 130. When the pressing plate 151 is not set while the mixed-size document reading mode is set, the main control unit 6 displays, on the control panel 130, a warning that the pressing plate 151 is not set on the document conveying device 3.

In step S1701, documents are placed with the pressing plate 151 closed. In other words, the main control unit 6 determines that the pressing plate 151 is at the storage position. In step S1702, the start button is pressed on the control panel 130 by the user with the mixed-size document reading mode unselected. In step S1703, the main control unit 6 determines the reading operation mode. When the reading operation mode is the normal mode (YES in step S1703), in step S1704, the main control unit 6 instructs the image reading device 2 to initiate the document conveying and reading operations in the normal mode.

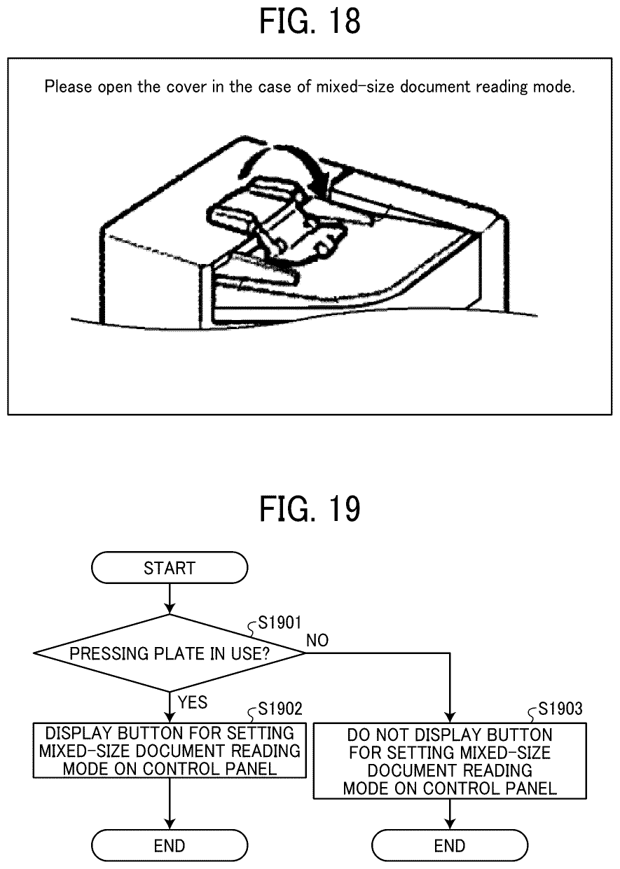

By contrast, when the mixed-size document reading mode is set (NO in step S1703), in step S1705, the main control unit 6 causes the image reading device 2 to stop the document conveying and reading operations. In step S1706, the main control unit 6 displays a warning indicating that the pressing plate 151 is not open, as illustrated in FIG. 18. When the user forgets to open the pressing plate 151, the user can determine an inconsistency between the reading operation mode and the position of the pressing plate 151 by checking the display on the control panel 130. In step S1707, the main control unit 6 determines whether the pressing plate 151 is opened based on a result of detection by the detector 155. When the user moves the pressing plate 151 from the storage position in response to the display presented in FIG. 18, the detector 155 detects that the pressing plate 151 is opened from the storage position. When the main control unit 6 determines that the pressing plate 151 is opened based on the detection (YES in step S1707), in step S1708, the main control unit 6 causes the image reading device 2 to initiate the document conveying and reading operations in the mixed-size document reading mode. By contrast, when the detector 155 does not detect that the pressing plate 151 is opened from the storage position and therefore the main control unit 6 determines that the pressing plate 151 is not opened (NO in step S1707), the process returns to step S1706.

The example illustrated in FIG. 17 prevents skewed conveyance of documents resulting from the lack of pressure to the documents by the pressing plate 151, which may occur when reading in the mixed-size document reading mode is set without opening the pressing plate 151. As a result, conveyance failures in the document conveying device 3 are also prevented.

FIG. 19 is a flowchart of a process performed by the image forming apparatus 1 to display or not to display a button for setting the mixed-size document reading mode on the control panel 130 when the pressing plate 151 is not set on the document table 120. In the example illustrated in FIG. 19, in step S1901, the main control unit 6 determines whether the pressing plate 151 is in use. When the main control unit 6 determines that the pressing plate 151 is in use based on the detection that the pressing plate 151 is opened to the usage position (YES in step S1901), in step S1902, the main control portion 6 displays, on the control panel 130, the button for setting the mixed-size document reading mode. In other words, when the detector 155 does not detect the pressing plate 151, the main control unit 6 displays, on the control panel 130, a screen for setting the reading conditions associated with use of the pressing plate 151. When the start button is pressed after the reading conditions associated with the use of the pressing plate 151 are set, the main control unit 6 executes the mixed-size document reading operation.

By contrast, when the detector 155 detects that the pressing plate 151 is moved to the storage position and therefore the main control unit 6 determines that the pressing plate 151 is not in use (NO in step S1901), in step S1903, the main control unit 6 does not display, on the control panel 130, the button for setting the mixed-size document reading mode. After that, when the start button is pressed, the main control unit 6 executes document reading and conveying operations under normal operating conditions. The example illustrated in FIG. 19 prevents the user from forgetting settings for reading documents in the mixed-size document reading mode.

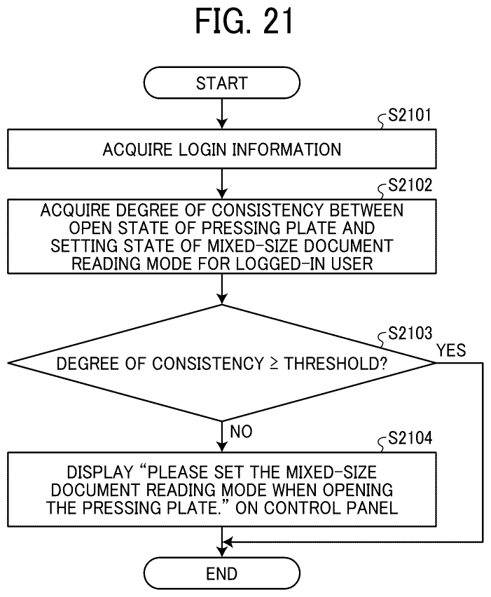

FIG. 20 is a diagram illustrating a configuration of the main control unit 6 and an artificial intelligence (AI) accelerator 905 of the image forming apparatus 1. FIG. 21 is a flowchart of a process for displaying a message on the control panel 130 of the image forming apparatus 1. The main control unit 6 includes a central processing unit (CPU) 910 and a memory 915. The main control unit 6 is connected with the AI accelerator 905. The memory 915 includes an image storage area 915A and stores a trained model 915B. The image storage area 915A is a memory area that temporarily stores data processed by the user.

The trained model 915B outputs, for example, the degree of consistency between the opening (movement) of a document pressing member (the pressing plate 151) to the usage position by the user and the setting of the mixed-size document reading mode. For example, when the document pressing member (the pressing plate 151) is opened while the mixed-size document reading mode is not set, or when the document pressing member (the pressing plate 151) remains closed (stays at the storage position) while the mixed-size document reading mode is set, the main control unit 6 determines an inconsistency between the state (position) of the document pressing member (the pressing plate 15) and the reading mode.

A learning device performs machine learning based on a training dataset to generate the trained model 915B. In other words, the trained model 915B is generated by applying supervised learning to a base training model.

The trained model 915B is obtained through machine learning using a training dataset based on the combination of the open state of the document pressing member (the pressing plate 151) and the setting state of the mixed-size document reading mode in advance.

Specifically, the trained model 915B is generated by machine learning based on a training dataset that indicates user information, the open state of the document pressing member (the pressing plate 151), and the setting state of the mixed-size document reading mode. Further, the training dataset may include information indicating the condition and type of the document.

As the machine learning used to generate the trained model 915B, for example, a neural network may be applied. As another example, deep learning, which is machine learning using a deep neural network (DNN), may be applied. As deep learning, for example, a convolutional neural network, a recurrent neural network (RNN), or a long short-term memory (LSTM) may be applied.

The AI accelerator 905 is a hardware component to accelerate model inference processing in a neural network. As the AI accelerator 905, a graphics processing unit (GPU) may be used, or an application-specific integrated circuit (ASIC) dedicated to an AI accelerator may be used.

The AI accelerator 905 is provided with a library to use the trained model 915B. For this reason, the AI accelerator 905 may include an inference unit for the trained model 915B stored in the memory 915. The AI accelerator 905 is capable of executing image recognition using deep learning.

The CPU 910 of the main control unit 6 controls the operation of the image forming apparatus 1 and the operation inputs from the user. The CPU 910 implements each functional block by executing a program stored in the memory 915. Each functional block in the CPU 910 is conceptual, and is not necessarily physically configured as illustrated in FIG. 20. All or some of the functional blocks may be configured by being functionally or physically distributed or integrated in any unit. The CPU 910 includes an acquisition unit 911, a determination unit 912, a display control unit 913, and a scanner control unit 914 by implementing a program.

The acquisition unit 911 acquires various types of information input into the main control unit 6 and the detection results from various sensors. For example, in step S2101 of FIG. 21, the acquisition unit 911 acquires login information when a user logs in by, for example, inputting identification (ID) information or holding an ID card over a contactless reader on the control panel 130.

The acquisition unit 911 further acquires the open state of the document pressing member (the pressing plate 151) and the setting result of the mixed-size document reading mode.

In step S2102, the determination unit 912 outputs the open state of the document pressing member (the pressing plate 151) and the setting result of the mixed-size document reading mode acquired by the acquisition unit 911, to the AI accelerator 905. The determination unit 912 then receives the degree of consistency between the open state of the document pressing member (the pressing plate 151) and the setting state of the mixed-size document reading mode, from the AI accelerator 905. The determination unit 912 may further receive information indicating an area having a degree of consistency between the open state of the document pressing member (the pressing plate 151) and the setting state of the mixed-size document reading mode lower than a predetermined threshold, as well as the condition and type of the document, from the AI accelerator 905.

In step S2103, the determination unit 912 determines whether the degree of consistency between the open state of the document pressing member (the pressing plate 151) and the setting state of the mixed-size document reading mode is equal to or greater than the predetermined threshold. When the degree of consistency between the open state of the document pressing member (the pressing plate 151) and the setting state of the mixed-size document reading mode is equal to or greater than the predetermined threshold (YES in step S2103), the process illustrated in FIG. 21 ends. By contrast, when the degree of consistency between the open state of the document pressing member (the pressing plate 151) and the setting state of the mixed-size document reading mode is smaller than the predetermined threshold (NO in step S2103), the determination unit 912 determines that the way in which the logged-in user uses the document pressing member (the pressing plate 151) is anomalous. In other words, the determination unit 912 determines that the logged-in user is a user who makes mistakes in setting the document pressing member (the pressing plate 151). In this case, once the user is authenticated, in step S2104, the main control unit 6 displays a message such as “Please set the mixed-size document reading mode when opening the document pressing member.” on the control panel 130 to inform the user, who often makes mistakes, of the inconsistency between the state of the document pressing member (the pressing plate 151) and the reading mode. In other words, when the main control unit 6 acquires the login information of the user, the main control unit 6 displays operational instructions such as the above described message on the control panel 130, which is an example of a display, based on the degree of consistency between the open state of the pressing plate 151 and the setting state of the mixed-size document reading mode for the user who has logged in.

The determination unit 912 outputs the open state of the document pressing member (the pressing plate 151) and the setting result of the mixed-size document reading mode to the AI accelerator 905 to receive the degree of consistency between the open state of the document pressing member (the pressing plate 151) and the setting state of the mixed-size document reading mode by deep learning in real time. The present disclosure is not limited to the example of processing using the AI accelerator 905 herein described.

The display control unit 913 controls the display of information on the control panel 130.

The scanner control unit 914 outputs instructions to the scanner 4 as to whether to perform reading. The display control unit 913 and the scanner control unit 914 perform control based on the determination result from the determination unit 912. Accordingly, the main control unit 6 can switch the control based on the degree of consistency between the open state of the document pressing member (the pressing plate 151) and the setting state of the mixed-size document reading mode, where the inconsistency is recognized based on the open state of the document pressing member (the pressing plate 151) and the setting result of the mixed-size document reading mode acquired by the acquisition unit 911.

As described above, the image forming apparatus 1 can perform the mixed-size document reading operation, which is an operation for detecting document edges to determine document size and correct skew. The image forming apparatus 1 can determine whether the image forming apparatus 1 is ready for the mixed-size document reading operation based on the state of the pressing plate 151 of the document conveying device 3, without leaving the operation setting to the user.

### First Modification

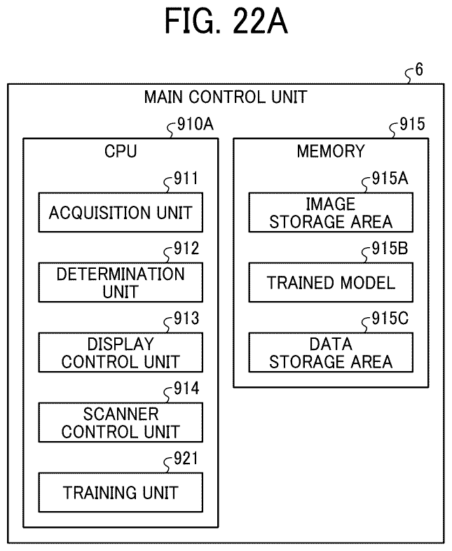

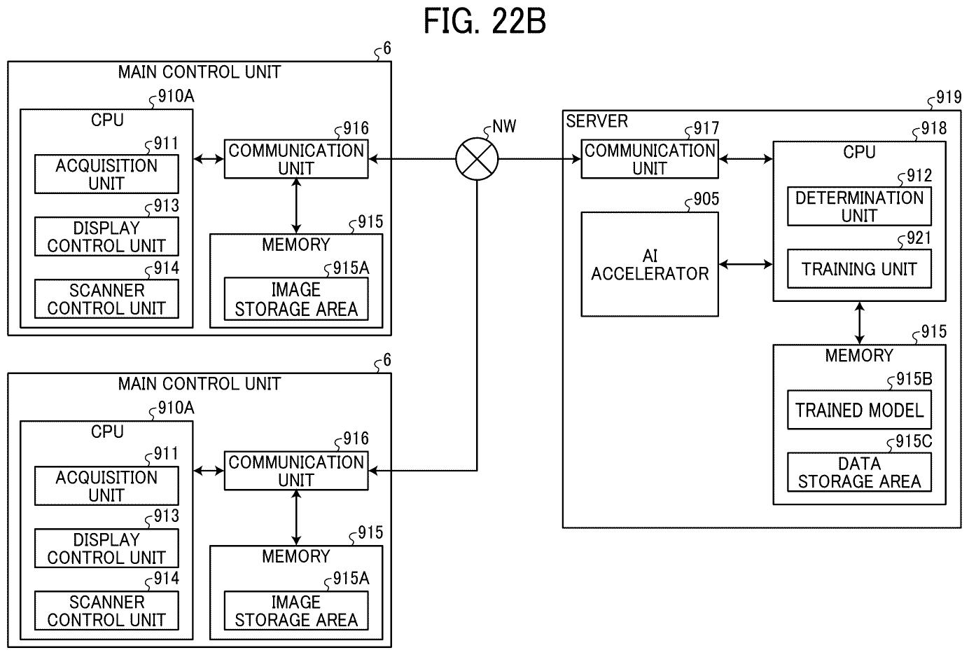

FIGS. 22A and 22B are diagrams each illustrating a configuration of one or more main control units of an image forming apparatus according to a first modification. In the present modification, the other components, such as the AI accelerator 905, are substantially similar to those described in the above embodiment. Accordingly, a detailed description thereof is omitted.

In the modified example illustrated in FIG. 22A, the main control unit 6 includes a CPU 910A and the memory 915, which is different from the memory 915 described in the above embodiment in that the memory 915 illustrated in FIG. 22A further includes a data storage area 915C. The CPU 910A is different from the CPU 910 described in the above embodiment in that the CPU 910A further includes a training unit 921.

The data storage area 915C stores data for additional training of the trained model 915B. The data storage area 915C stores at least the user information, the open state of the document pressing member (the pressing plate 151), and the setting state of the mixed-size document reading mode in association with each other. In the present modified example, the memory 915 is included in the main control unit 6, that is, in the image forming apparatus 1.

In the modified example illustrated in FIG. 22B, the memory 915 is included in an external server 919 outside the image forming apparatus 1. Although the external server 919 is connected to multiple image forming apparatuses 1 via a communication network NW in FIG. 22B, the external server 919 may be connected to a single image forming apparatus 1.

The training data stored in the memory 915 of the external server 919 is commonly used for the determinations of the individual image forming apparatuses 1. The determination results of the individual image forming apparatuses 1 are reflected in the training data, which can be used for the determinations of the image forming apparatuses 1. The main control unit 6 may be included in the external server 919, which is an example of a server.

The training unit 921 generates training data based on the data stored in the data storage area 915C, and performs additional training of the trained model 915B using the generated training data. The trained model 915B, subjected to additional training, is incorporated into the AI accelerator 905. The inference unit of the AI accelerator 905 can execute inference processing using the trained model 915B subjected to the additional training.

The inference unit of the AI accelerator 905 is not limited to the example in which the degree of consistency between the open state of the document pressing member (the pressing plate 151) and the setting state of the mixed-size document reading mode is output when the user is authenticated. Alternatively, the inference unit may output a value indicating the type or condition of the document. Then, the determination unit 912 determines whether to read the document based on the input value. Another trained model may be provided for the determination of whether to read the document, based on the input value.

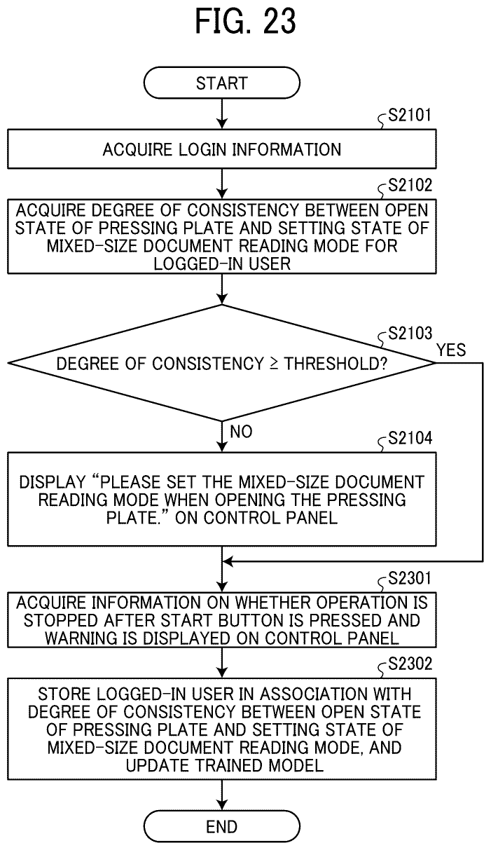

FIG. 23 is a flowchart of a process for updating a trained model stored in the main control unit 6 according to the first modification. A detailed description of operations similar to those described above with reference to FIG. 21 is omitted in the following description.

After the main control unit 6 displays a message such as “Please set the mixed-size document reading mode when opening the document pressing member.” on the control panel 130 in step S2104, in step S2301, the acquisition unit 911 acquires information on whether the reading operation is stopped and a warning is displayed on the control panel 130. In step S2302, the training unit 921 stores the logged-in user in association with the degree of consistency between the open state of the document pressing member and the setting state of the mixed-size document reading mode in the memory 915, and updates the trained model 915B.

Although the acquisition unit 911 acquires login information when the user logs in by inputting ID information or holding the ID card over the contactless reader on the control panel 130 in step S2101, the login information to be acquired is not limited to such information. In the modified example illustrated in FIG. 22B, the acquisition unit 911 may acquire, as login information, the apparatus information of the image forming apparatus 1 that has started the operation among the multiple image forming apparatuses 1 connected to the external server 919. In this case, the trained model 915B of the external server 919 is obtained through machine learning using a training dataset based on the combination of the open state of the pressing plate 151 and the setting state of the mixed-size document reading mode for each connected image forming apparatus 1.

Then, the open state of the document pressing member (the pressing plate 151) and the setting result of the mixed-size document reading mode acquired by the acquisition unit 911 of the image forming apparatus 1 that has started the operation is output to the AI accelerator 905 of the external server 919 via a communication unit 916, the communication network NW, and a communication unit 917. The determination unit 912 of the external server 919 receives the degree of consistency between the open state of the document pressing member (the pressing plate 151) and the setting state of the mixed-size document reading mode from the AI accelerator 905 (step S2102). The determination unit 912 of the external server 919 determines whether the degree of consistency between the open state of the document pressing member (the pressing plate 151) and the setting state of the mixed-size document reading mode of the image forming apparatus 1 that has started the operation is equal to or greater than the predetermined threshold (step of S2103). In other words, the determination unit 912 of the external server 919 is an example of a determination unit that makes determinations based on the detection results of the pressing plate 151 detected by the detector 155. The determination result is output to the acquisition unit 911 of the image forming apparatus 1 that has started the operation via the communication unit 917, the communication network NW, and the communication unit 916. When the determination result indicates a value equal to or greater than the predetermined threshold (YES in step S2103), the process proceeds to step S2301. By contrast, when the determination result indicates a value lower than the predetermined threshold (NO in step S2103), in step S2104, the main control unit 6 of the image forming apparatus 1 that has started the operation displays a message such as “Please set the mixed-size document reading mode when opening the document pressing member.” on the control panel 130 to inform the user of the image forming apparatus 1, who often makes mistakes, of the inconsistency between the state of the document pressing member (the pressing plate 151) and the reading mode. In other words, the main control unit 6 of the image forming apparatus 1 is an example of a control unit that performs control based on information indicating the determination from the determination unit 912 of the external server 919.

Although the detector 155 detects whether the pressing plate 151 is present at the retracted position in the above embodiment, the detector 155 may detect whether the pressing plate 151 is at the contact position where the pressing plate 151 contacts a document in another embodiment. In this case, in each flowchart, the determination unit 912 determines that the pressing plate 151 has moved from the storage position to the usage position based on the result of detecting whether the pressing plate 151 is present at the contact position.

Alternatively, the detector 155 may include both a detector that detects whether the pressing plate 151 is present at the retracted position and a detector that detects whether the pressing plate 151 is present at the contact position where the pressing plate 151 contacts a document. For example, when the pressing plate 151 is not securely stored at the storage position, the detector 155 detects the absence of the pressing plate 151 at the retracted position. However, when the detector 155 does not detect the pressing plate 151 at the contact position whether the pressing plate 151 contacts a document, the determination unit 912 determines that the pressing plate 151 is stored at the storage position and determines the usage state as in the above-described flowchart.

The image forming apparatus 1 has been described as a multifunction peripheral (MFP) having at least two of copying, printing, scanning, and facsimile functions. However, the present disclosure can be applied to any image forming apparatus, such as a copier, printer, scanner, or facsimile machine.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc read-only memory (CD-ROM) or digital versatile disk (DVD), and/or the memory of an FPGA or ASIC.

1. A document reading device, comprising:
a document stacker on which a document is placed;
a conveyor to convey the document placed on the document stacker;
a reader to read the document conveyed by the conveyor;
a document presser movable between a contact position at which the document presser contacts the document placed on the document stacker and a retracted position at which the document presser is retracted from the document;
a detector to detect whether the document presser is present at one or both of the contact position and the retracted position; and
circuitry configured to perform control based on a detection result of the document presser detected by the detector.

2. The document reading device according to claim 1, further comprising an input device to receive an input for setting a reading condition of the document,
wherein the circuitry is configured to control a conveying operation of the conveyor based on the reading condition set through the input device and the detection result of the document presser detected by the detector.

3. The document reading device according to claim 2,
wherein the circuitry is configured to output, on a display, a prompt indicating that a location of the document presser or the reading condition is to be changed.

4. The document reading device according to claim 2,
wherein, when the detector does not detect the document presser and the reading condition is not set to a reading condition associated with use of the document presser, the circuitry is configured to execute conveying and reading operations for the document under the reading condition associated with the use of the document presser.

5. The document reading device according to claim 2,
wherein, when the detector does not detect the document presser, the circuitry displays, on a display, a screen for setting the reading condition associated with use of the document presser.

6. An image forming apparatus, comprising:
a document stacker on which a document is placed;
a conveyor to convey the document placed on the document stacker;
a reader to read the document conveyed by the conveyor;
an image forming device to form an image on a recording medium based on an image read by the reader;
a document presser movable between a contact position at which the document presser contacts the document placed on the document stacker and a retracted position at which the document presser is retracted from the document;
a detector to detect whether the document presser is present at one or both of the contact position and the retracted position; and
circuitry configured to perform control based on a detection result of the document presser detected by the detector.

7. The image forming apparatus according to claim 6,
wherein, when the circuitry acquires login information of a user, the circuitry is configured to display an operational instruction on a display, based on a degree of consistency between an open state of the document presser and a setting state of a mixed-size document reading mode for the user who has logged in.

8. An image forming system, comprising:
a document reading device including:
a document stacker on which a document is placed;
a conveyor to convey the document placed on the document stacker;
a reader to read the document conveyed by the conveyor;
a document presser movable between a contact position at which the document presser contacts the document placed on the document stacker and a retracted position at which the document presser is retracted from the document;
a detector to detect whether the document presser is present at one or both of the contact position and the retracted position; and
device circuitry; and
a server including server circuitry configured to make a determination based on a detection result of the document presser detected by the detector,
the device circuitry being configured to perform control based on information indicating the determination from the server circuitry.
